(19) United States
(12) Patent Application Publication
(10) Pub. No.: US 2015/0161421 A1
(43) Pub. Date: Jun. 11, 2015

(54) APPARATUS AND METHOD FOR CONTROLLING SUPPLY OF POWER TO RADIO FREQUENCY IDENTIFICATION TAG

(71) Applicant: Electronics and Telecommunications Research Institute, Daejeon (KR)

(72) Inventors: Sang Yeoun LEE, Daejeon (KR); Kang Bok LEE, Daejeon (KR); Kyu Ha BAEK, Daejeon (KR)

(73) Assignee: Electronics and Telecommunications Research Institute, Daejeon (KR)

(21) Appl. No.: 14/194,714

(22) Filed: Mar. 1, 2014

(30) Foreign Application Priority Data
Dec. 9, 2013 (KR) 10-2013-0152175

(51) Int. Cl. G06K 7/10

(52) U.S. Cl. CPC G06K 7/10207

(57) ABSTRACT

Provided is an apparatus for controlling supply of power to a radio frequency identification (RFID) tag, in which an internal large-capacity memory of an RFID tag is physically divided into a plurality of memory blocks, and power is selectively supplied to each of the divided plurality of memory blocks depending on the case, thereby reducing power consumption of the RFID tag. The apparatus includes a first memory configured to store information which is used to perform an inventory operation with an RFID reader, a second memory configured to store a file and data associated with the RFID tag, and a control unit configured to perform the inventory operation with the RFID reader by using the inventory information stored in the first memory, and when a command for accessing the second memory is received from the RFID reader, allow power to be supplied to the second memory.

### CROSS-REFERENCE TO RELATED APPLICATIONS

This application claims priority under 35 U.S.C. §119 to Korean Patent Application No. 10-2013-0152175, filed on Dec. 9, 2013, the disclosure of which is incorporated herein by reference in its entirety.

### TECHNICAL FIELD

The present invention relates to an apparatus and method for controlling supply of power to a radio frequency identification (RFID) tag, and more particularly, to an apparatus and method for controlling supply of power to an RFID tag, in which an internal large-capacity memory of an RFID tag is divided into a plurality of physical memory blocks, and power is selectively supplied to only a desired memory block through command analysis of an RFID reader.

### BACKGROUND

Generally, RFID technology denotes technology that contactlessly communicates with a tag having unique identification information by using a radio frequency to read information from the tag or to write information in the tag. The RFID technology is applied to various fields that recognize, trace, and manage an object (for example, a thing, an animal, a person, or the like) with a tag attached thereto. In particular, recent RFID technology has a function of sensing ambient environmental information in addition to a function of transmitting unique identification information, and thus, the application range of the RFID technology is being further expanded.

An RFID system includes a plurality of tags (electronic tags or transponders), which are respectively attached to a plurality of objects and store unique identification information, and an RFID reader (interrogator) that reads information stored in a corresponding tag or writes information in the corresponding tag.

The RFID system is categorized into an inductive coupling type and an electromagnetic wave type depending on a mutual communication scheme between a reader and a tag.

Moreover, the RFID system is categorized into an active type and a passive type depending on whether a tag operates with self-power, and depending on a using frequency, the RFID system is categorized into a long wave type, a medium wave type, a short wave type, an ultrashort wave type, and a microwave type. Due to the types of the RFID systems, various kinds of standards were established, or are being prepared to establish.

An inventory command set is defined in most of RFID air specifications. Here, the inventory command denotes a command that is transmitted by a reader so as to singulate a tag.

Generally, referring to ISO/IEC 18000-6 REV1 and EPCglobal Class-1 Generation-2, an acknowledgement (ACK) command is a command that is transmitted from a reader to a specific tag so as to acknowledge the specific tag. As a result, the tag backscatters a predetermined bit-stream. The bit-stream may be processed by the reader (or a middleware of the reader) so as to identify the tag.

A related art apparatus for supplying power to a memory of an RFID tag will now be described with reference to FIG. 1.

FIG. 1 is a functional block diagram schematically illustrating a related art apparatus for supplying power to an RFID tag.

As illustrated in FIG. 1, the related art apparatus for supplying power to an RFID tag includes a transmission/reception unit 10, a modulation/demodulation unit 11, a control unit 12, and a memory 13.

The transmission/reception unit 10 transmits/receives data to/from an RFID reader (not shown), and includes a power supply that generates power by using a high frequency signal or a low frequency signal which is received from the RFID reader, and supplies the generated power as operational power of each element of the RFID tag.

The modulation/demodulation unit 11 decodes data which is received through the transmission/reception unit 10, and encodes data, which is to be transmitted to the RFID reader, to the encoded data to the transmission/reception unit 10.

The control unit 12 performs an inventory operation for controlling an access of the RFID reader, and when the inventory operation is completed, the control unit 12 stores data, obtained through decoding by the modulation/demodulation unit 11, in the memory 13, or reads the data from the memory 13 to supply the read data to the modulation/demodulation unit 11, according to a command of the RFID reader. Here, the memory 13 may include an area that stores information about an arbitrary object with a tag attached thereto, an area that stores information about a user which uses a thing, an area that stores inventory information (for example, authentication code) used to perform an inventory operation, and an area that stores data written by the RFID reader.

That is, the control unit 12 stores/reads data in/from each of the areas of the memory 13, stores an authentication check code, used to perform the inventor operation with the RFID reader, in each area of the memory 13, and performs the inventory operation between the RFID reader and the RFID tag by using the stored authentication check code. When the inventory operation is completed, the control unit accesses a corresponding area of the memory 13 to write/read data in/from the corresponding area, according to a command received from the RFID reader.

The RFID tag (a passive type) operates with power supplied from the RFID reader, and thus, much time and power are consumed in an operation where the RFID reader writes data in the memory 13 provided in the RFID tag.

Recently, as a security function and a file management function of a passive RFID tag are strengthened, it is a trend that additionally stores security-related information and file-related information, in addition to the existing user interface (UI) information, in a memory of the passive RFID tag.

One file may be stored in the memory of the RFID tag, but several files may be stored in the memory according to EPC Global Gen V2.0. When supporting several files, the RFID tag includes one large-capacity memory for managing the several files.

As described above, in a case where the memory of the RFID tag is a large-capacity memory, driving power is continuously supplied to the large-capacity memory when a command packet is received from the RFID reader. For this reason, much power consumption is caused by a capacity of the memory, and due to the much power consumption, a recognition distance between the RFID reader and the RFID tag becomes shorter.

Therefore, research and development are needed for reducing power consumption of the RFID tag when a large-capacity memory is applied to the RFID tag.

### SUMMARY

Accordingly, the present invention provides an apparatus and method for controlling supply of power to an RFID tag, in which an internal large-capacity memory of an RFID tag is physically divided into a plurality of memory blocks, and power is selectively supplied to each of the divided plurality of memory blocks depending on the case, thereby reducing power consumption of the RFID tag.

In one general aspect, an apparatus for controlling supply of power to a radio frequency identification (RFID) tag includes: a first memory configured to store information which is used to perform an inventory operation with an RFID reader; a second memory configured to store a file and data associated with the RFID tag; and a control unit configured to perform the inventory operation with the RFID reader by using the inventory information stored in the first memory, and when a command for accessing the second memory is received from the RFID reader, allow power to be supplied to the second memory.

The apparatus may further include: a power generation unit configured to generate the power by using a radio frequency signal received from the RFID reader; and a switching unit configured to selectively supply the power, generated by the power generation unit, to the second memory according to a switching control signal supplied from the control unit.

The second memory may include a plurality of memories configured to store a file and data associated with the RFID tag, and the control unit may control the switching unit so that the power is supplied to at least one of the plurality of memories of the second memory.

The switching unit may include an on/off switch connected between the power generation unit and the second memory, and configured to allow the power, generated by the power generation unit, to be supplied to or disconnected from the second memory according to the switching control signal supplied from the control unit.

In another general aspect, an apparatus for controlling supply of power to a radio frequency identification (RFID) tag includes: an inventory memory configured to store information which is used to perform an inventory operation with an RFID reader; a data memory configured to store a file and data associated with the RFID tag; a power generation unit configured to generate the power which is supplied to each element of the RFID tag, by using a signal received from the RFID reader; a control unit configured to perform the inventory operation with the RFID reader by using the inventory information stored in the inventory memory, and when the inventory operation is completed and a command for accessing the data memory is received from the RFID reader, generate a switching control signal that allows the power to be supplied to the data memory; and a switching unit configured to selectively supply the power, generated by the power generation unit, to the data memory according to the switching control signal generated by the control unit.

The data memory may include a plurality of memories configured to store a file and data associated with the RFID tag, and the control unit may controls the switching unit so that the power is supplied to at least one of the plurality of memories of the data memory.

The switching unit may include an on/off switch connected between the power generation unit and the data memory, and configured to allow the power, generated by the power generation unit, to be supplied to or disconnected from the data memory according to the switching control signal supplied from the control unit.

The apparatus may further include: a transmission/reception unit configured to receive a command from the RFID reader, and transmit corresponding data to the RFID reader according to the received command; and a modulation/demodulation unit configured to decode a command received through the transmission/reception unit to supply the decoded command to the control unit, and demodulate data, obtained by executing a corresponding command from the control unit, to supply the demodulated data to the RFID reader through the transmission/reception unit.

In another general aspect, a memory structure of an RFID tag includes: an inventory memory configured to store information which is used to perform an inventory operation with an RFID reader; and at least one or more data memories configured to store a file and data associated with the RFID tag, and only when the inventory operation with the RFID reader is completed by using the inventory memory and an access command is received from the RFID reader, operate with power supplied thereto.

In another general aspect, a method of controlling supply of power to an RFID tag includes: separating a first memory block, which is configured to store information used to perform an inventory operation with an RFID reader, and a second memory block configured to store a file and data associated with the RFID tag; and supplying power to the second memory block when the inventory operation with the RFID reader is completed by using the inventory information stored in the first memory and a command for accessing the second memory block is received from the RFID reader.

The controlling may include: generating the power by using a radio frequency signal received from the RFID reader; and selectively supplying the generated power to the second memory block according to a switching control signal.

The supplying may include: performing the inventory operation with the RFID reader by using the inventory information stored in the first memory block; determining whether an authentication and file access operation is completed after the inventory operation between the RFID reader and the RFID tag is completed; and when it is determined that the authentication and file access operation is completed, supplying the generated power to the second memory block.

The determining may include, when the authentication and file access operation is not completed, performing the inventory operation or the authentication and file access operation in a state where the power is not supplied to the second memory block.

In another general aspect, a method of controlling supply of power to an RFID tag includes: separating a first memory block, which is configured to store inventory information used to perform an inventory operation with an RFID reader, and a second memory block configured to store a file and data associated with the RFID tag; generating the power which is supplied to each element of the RFID tag, by using a signal received from the RFID reader; performing the inventory operation with the RFID reader by using the inventory information stored in the first memory block; and selectively supplying the generated power to the second memory block or cutting off the generated power, according to whether a command for accessing the second memory block is received from the RFID reader after the inventory operation is completed.

The controlling may include: determining whether the inventory operation between the RFID reader and the RFID tag is ended; and when it is determined that the command for accessing the second memory block is received from the RFID reader after the inventory operation is completed, supplying the generated power to the second memory block, and when a command for accessing another memory block is received, supplying the generated power to the other memory block in a state where the power is not supplied to the second memory block.

Other features and aspects will be apparent from the following detailed description, the drawings, and the claims.

### BRIEF DESCRIPTION OF THE DRAWINGS

FIG. 1 is a block diagram illustrating a related art apparatus for supplying power to an RFID tag.

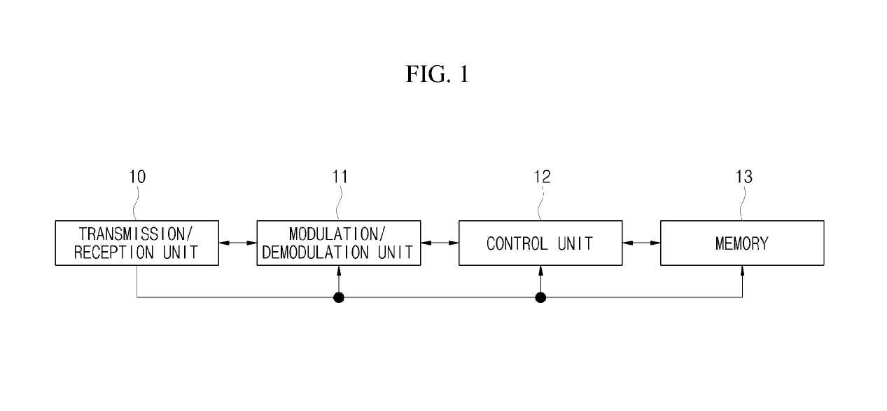

FIG. 2 is a block diagram illustrating an apparatus for controlling supply of power to an RFID tag according to an embodiment of the present invention.

FIG. 3 is a flowchart illustrating a method of controlling supply of power to an RFID tag according to an embodiment of the present invention.

### DETAILED DESCRIPTION OF EMBODIMENTS

Hereinafter, an apparatus and method for controlling supply of power to an RFID tag according to the present invention will be described in detail with reference to the accompanying drawings.

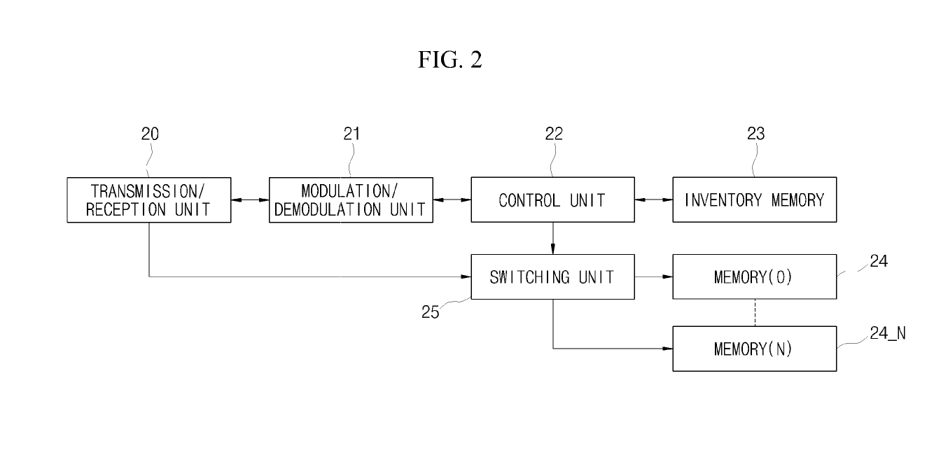

FIG. 2 is a block diagram illustrating an apparatus for controlling supply of power to an RFID tag according to an embodiment of the present invention.

Referring to FIG. 2, the an apparatus for controlling supply of power to an RFID tag according to an embodiment of the present invention includes a transmission/reception unit 20, a modulation/demodulation unit 21, a control unit 22, an inventory memory 23, and a plurality of memories 24 to 24-N (where N is a natural number equal to or more than two).

First, the inventory memory 23 stores inventory information which is used to perform an inventory operation between an RFID reader and an RFID tag.

The memories 24 to 24-N may be divided into a plurality of memories that store a file and data associated with the RFID tag.

The memories 24 to 24-N are memories that are accessible in communication (for example, in the case of an open or secured state area in Gen2) between the RFID reader and the RFID tag after the control unit 12 performs the inventory operation between the RFID reader and the RFID tag by using the inventory memory 23.

The transmission/reception unit 20 transmits/receives data to/from the RFID reader (not shown), and includes a power supply (not shown) that generates power by using a received high frequency signal or a received low frequency signal.

The power generated by the power supply of the transmission/reception unit 20 is supplied as operational power of each element of the RFID tag. Here, when the control unit 22 completes the inventory operation between the RFID reader and the RFID tag, the transmission/reception unit 20 selectively supplies the power to the memories 24 to 24-N according to control by the control unit 22. Such a power supply controlling operation will be described below in detail.

The modulation/demodulation unit 21 decodes data which is received through the transmission/reception unit 20, and encodes data, which is to be transmitted to the RFID reader, to the encoded data to the transmission/reception unit 20.

The control unit 22 performs the inventory operation for controlling an access of the RFID reader by using the inventory information stored in the inventory memory 23, and when the inventory operation is completed, according to a command of the RFID reader, the control unit 22 stores data (which is obtained through decoding by the modulation/demodulation unit 21) in a corresponding memory of the memories 24 to 24-N, and stores data received from the modulation/demodulation unit 11 in a corresponding memory of the memories 24 to 24-N or reads the data stored in each of the memories 24 to 24-N to supply the read data the modulation/demodulation unit 21.

In order to access a file or a memory (one of 24 to 24-N) which the RFID reader desires, the control unit 22 performs the inventory operation, and then performs a procedure for accessing the memory. Such a procedure will now be described.

First, the RFID reader performs an authentication operation of obtaining a file authority according to EPC Global Gen V2.0 standard by using the control unit 22 of the RFID tag. In this case, the control unit 22 transmits an authentication code to the RFID reader by using the inventory information stored in the inventory memory 23, and receives a response signal based on the transmitted authentication code, thereby performing the authentication operation between the RFID reader and the RFID tag. That is, the RFID reader performs the authentication operation of obtaining the file authority for accessing the memories 24 to 24-N according to the standard, and when the authentication operation is completed, the RFID tag executes a command (for example, a file open command) received from the RFID reader. Here, an authentication file access operation between the RFID reader and the RFID tag are known technologies, and thus, its detailed description is not provided. According to the present embodiment, the RFID tag supplies the power to only a memory, which the RFID reader desires to access, among the memories 24 to 24-N which are physically separated from the inventory memory 23.

As described above, when the inventory operation between the RFID reader and the RFID tag is completed, the control unit 22 controls a switching unit 25 in order for the power to be supplied to a memory which the RFID reader desired to access, according to a command included in a packet received from the RFID reader. For example, when the RFID reader desires to access the memory 24 and read desired data from the memory 24, the control unit 22 supplies a switching control signal to the switching unit 25 so that the power generated by the power supply (not shown) of the transmission/reception unit 20 is supplied to only the memory 24. At this time, the control unit 22 controls the switching unit 25 in order for the power not to be supplied to the memories 24-1 to 24-N other than the memory 24. Here, the switching unit 25 may include a plurality of switches that are respectively connected to the memories 24 to 24-N, and are turned on/off according to the switching control signal supplied from the control unit 22 to supply the power supplied from the transmission/reception unit 20 to the memories 24 to 24-N or to cut off the power. Each of the switches may use an on/off switch that supplies the power to a corresponding memory or cuts off the power.

To summarize, the control unit 22 controls the switching unit 25 in order for the power not to be supplied to all the memories 24 to 24-N while the inventory operation between the RFID reader and the RFID tag is being performed. Only when the inventory operation is completed and the authentication command or file open command of the RFID reader is normally performed, the control unit 22 controls the switching unit 25 in order for the power to be supplied to only a memory which the RFID reader desires to access.

When a command (for example, data read/write) required by the RFID reader is completed for a corresponding memory which is supplied with the power, the control unit 22 controls the switching unit 25 in order for the power not to be supplied to the corresponding memory which is supplied with the power.

Hereinabove, technology that supplies the power to the memories 24 to 24-N and then stores/reads data in/from the memories 24 to 24-N supplied with the power according to a command of the RFID reader is known technology, and thus, its detailed description is not provided.

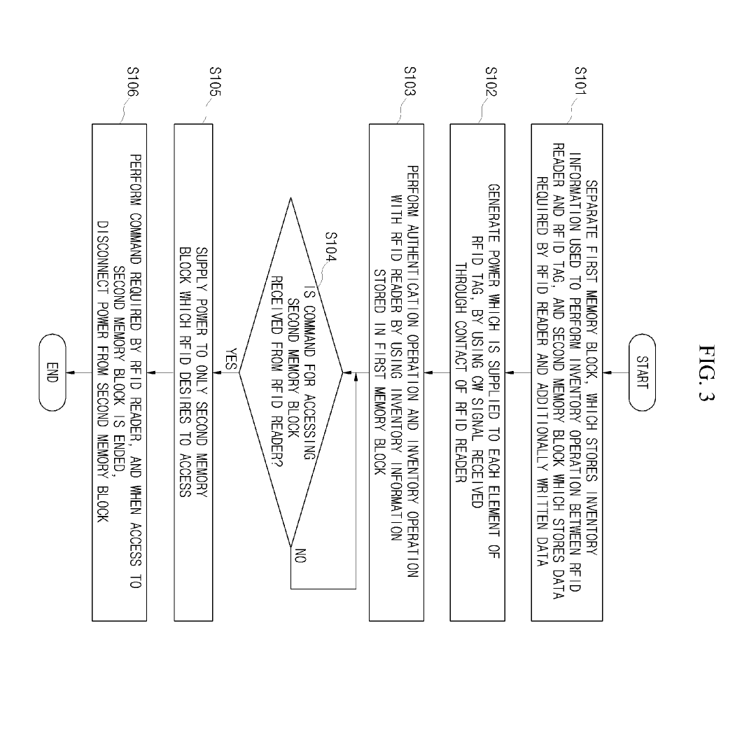

A method of controlling supply of power to an RFID tag according to an embodiment of the present invention, which corresponds to the apparatus for controlling supply of power to an RFID tag according to an embodiment of the present invention, will be sequentially described with reference to FIG. 3.

FIG. 3 is a flowchart illustrating a method of controlling supply of power to an RFID tag according to an embodiment of the present invention.

Referring to FIG. 3, first, a large-capacity memory of the RFID tag is divided into an inventory memory, which stores information used to perform the inventory operation between the RFID reader and the RFID tag, and at least one or more memories that store a file and data associated with the RFID tag, in operation S101.

In this state, the method generates power which is supplied to each element of the RFID tag, by using a continuous wave (CW) signal received through the contact of the RFID reader, in operation S102. That is, as described above, the method generates the power which is supplied to each element of the RFID tag, by using a high frequency signal or a low frequency signal which is received from the RFID reader.

In operation S103, the RFID tag decodes a received command, performs the inventory operation with the RFID reader by using inventory information stored in the inventory memory according to decoded data, and performs an authentication operation. In the inventory operation between the RFID reader and the RFID tag, the RFID reader performs an authentication operation of obtaining a file authority according to EPC Global Gen V2.0 standard. In this case, the RFID reader transmits an authentication code to the RFID tag by using the inventory information stored in the inventory memory, and a response signal based on the transmitted authentication code is transmitted to the RFID reader, thereby performing the authentication operation between the RFID reader and the RFID tag. That is, the RFID reader performs the authentication operation of obtaining the file authority for accessing a desired file or memory according to the standard, and when the authentication operation is completed, a corresponding operation is performed according to a command received from the RFID reader.

Subsequently, the method determines whether the authentication and file access operation is completed in operation S104, and when the inventory operation is being performed without the authentication operation being normally completed, the supply of the power is controlled in order for the power not to be supplied to the memories.

However, when it is determined that the authentication and file access operation are completed, the power is supplied to only a corresponding memory that stores a file and data associated with the RFID tag, in operation S105.

When a command (for example, data read/write) required by the RFID reader is completed for the corresponding memory which is supplied with the power, and a command for accessing the other memory is received, the power is supplied to only the corresponding memory, and the power is not supplied to the other memory, in operation S106. Here, a method that stores/reads data in/from the memory supplied with the power according to the command of the RFID reader is known technology, and thus, its detailed description is not provided.

According to the apparatus and method for controlling supply of power to the RFID tag, the large-capacity memory of the RFID tag is physically divided into a plurality of memory blocks, and power is selectively supplied to each of the divided plurality of memory blocks depending on the case, and the supply of power to each of the separated memories is selectively controlled depending on the case, thereby reducing power consumption of the RFID tag.

Moreover, according to the present invention, the power consumption of the RFID tag is reduced to the minimum, and thus, a wireless recognition distance between the RFID reader and the RFID tag is enhanced, thereby enhancing communication efficiency between the RFID reader and the RFID tag.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for controlling supply of power to a radio frequency identification (RFID) tag, the apparatus comprising:
a first memory configured to store information which is used to perform an inventory operation with an RFID reader;
a second memory configured to store a file and data associated with the RFID tag; and
a control unit configured to perform the inventory operation with the RFID reader by using the inventory information stored in the first memory, and when a command for accessing the second memory is received from the RFID reader, allow power to be supplied to the second memory.

2. The apparatus of claim 1, further comprising:
a power generation unit configured to generate the power by using a radio frequency signal received from the RFID reader; and
a switching unit configured to selectively supply the power, generated by the power generation unit, to the second memory according to a switching control signal supplied from the control unit.

3. The apparatus of claim 1, wherein,
the second memory comprises a plurality of memories configured to store a file and data associated with the RFID tag, and
the control unit controls the switching unit so that the power is supplied to at least one of the plurality of memories of the second memory.

4. The apparatus of claim 2, wherein the switching unit comprises an on/off switch connected between the power generation unit and the second memory, and configured to allow the power, generated by the power generation unit, to be supplied to or disconnected from the second memory according to the switching control signal supplied from the control unit.

5. The apparatus of claim 1, wherein,
the control unit comprises a power generation unit configured to generate the power which is supplied to each element of the RFID tag, by using a signal received from the RFID reader;
a controller configured to perform the inventory operation with the RFID reader by using the inventory information stored in the first memory, and when the inventory operation is completed and a command for accessing the second memory is received from the RFID reader, generate a switching control signal that allows the power to be supplied to the second memory; and
a switching unit configured to selectively supply the power, generated by the power generation unit, to the second memory according to the switching control signal generated by the controller.

6. The apparatus of claim 5, wherein,
the second memory comprises a plurality of memories configured to store a file and data associated with the RFID tag, and
the controller controls the switching unit so that the power is supplied to at least one of the plurality of memories of the second memory.

7. The apparatus of claim 5, wherein the switching unit comprises an on/off switch connected between the power generation unit and the second memory, and configured to allow the power, generated by the power generation unit, to be supplied to or disconnected from the second memory according to the switching control signal supplied from the controller.

8. The apparatus of claim 5, further comprising:
a transmission/reception unit configured to receive a command from the RFID reader, and transmit corresponding data to the RFID reader according to the received command; and
a modulation/demodulation unit configured to decode a command received through the transmission/reception unit to supply the decoded command to the controller, and demodulate data, obtained by executing a corresponding command from the controller, to supply the demodulated data to the RFID reader through the transmission/reception unit.

9. A memory structure of a radio frequency identification (RFID) tag, the memory structure comprising:
an inventory memory configured to store information which is used to perform an inventory operation with an RFID reader; and
at least one or more data memories configured to store a file and data associated with the RFID tag, and only when the inventory operation with the RFID reader is completed by using the inventory memory and an access command is received from the RFID reader, operate with power supplied thereto.

10. A method of controlling supply of power to a radio frequency identification (RFID) tag, the method comprising:
separating a first memory block, which is configured to store information used to perform an inventory operation with an RFID reader, and a second memory block configured to store a file and data associated with the RFID tag; and
supplying power to the second memory block when the inventory operation with the RFID reader is completed by using the inventory information stored in the first memory and a command for accessing the second memory block is received from the RFID reader.

11. The method of claim 10, wherein the controlling comprises:
generating the power by using a radio frequency signal received from the RFID reader; and
selectively supplying the generated power to the second memory block according to a switching control signal.

12. The method of claim 11, wherein the supplying comprises:
performing the inventory operation with the RFID reader by using the inventory information stored in the first memory block;
determining whether an authentication and file access operation is completed after the inventory operation between the RFID reader and the RFID tag is completed; and
when it is determined that the authentication and file access operation is completed, supplying the generated power to the second memory block.

13. The method of claim 12, wherein the determining comprises, when the authentication and file access operation is not completed, performing the inventory operation or the authentication and file access operation in a state where the power is not supplied to the second memory block.

14. The method of claim 10, wherein supplying comprises:
separating a first memory block, which is configured to store inventory information used to perform an inventory operation with an RFID reader, and a second memory block configured to store a file and data associated with the RFID tag;
generating the power which is supplied to each element of the RFID tag, by using a signal received from the RFID reader;
performing the inventory operation with the RFID reader by using the inventory information stored in the first memory block; and
selectively supplying the generated power to the second memory block or cutting off the generated power, according to whether a command for accessing the second memory block is received from the RFID reader after the inventory operation is completed.

15. The method of claim 14, wherein the supplying comprises:
determining whether the inventory operation between the RFID reader and the RFID tag is ended; and
when it is determined that the command for accessing the second memory block is received from the RFID reader after the inventory operation is completed, supplying the generated power to the second memory block, and when a command for accessing another memory block is received, supplying the generated power to the other memory block in a state where the power is not supplied to the second memory block.
